(19) United States
(12) Patent Application Publication
(10) Pub. No.: US 2008/0163611 A1
(43) Pub. Date: Jul. 10, 2008

(54) Procedure for the desulfurization of a storage catalyst and the device for the implementation of this procedure

(75) Inventors: Juergen Junginger, Koengen (DE); Stefan Scherer, Stuttgart (DE); Simone Hingst, Walzbachtal (DE); Christian Covini, Waiblingen (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 11/974,408

(22) Filed: Oct. 12, 2007

(30) Foreign Application Priority Data
Oct. 17, 2006 (DE) 10 2006 048 905.5

(51) Int. Cl. B01D 53/30; B01D 53/88; B01D 53/94; F01N 11/00

(52) U.S. Cl. 60/295; 60/273

(57) ABSTRACT

The invention suggests a procedure for the desulfurization of a storage catalyst, whereby the storage catalyst is run with a desulfurization temperature range that is required for the desulfurization, and whereby the storage catalyst is admitted with a regeneration gas with an air lambda of max. 1, as well as a device for the implementation of the procedure. During the desulfurization the storage catalyst is admitted in temporal shifts with a regeneration gas with an air lambda of max. even 1 during a desulfurization phase and a regeneration gas with an air lambda of higher than 1 during a desulfurization pause. Upstream before the storage catalyst an incoming lambda signal and downstream after the storage catalyst an outgoing lambda signal is acquired. By comparing the two signals that have been acquired during a desulfurization phase at least one favorable point of time for terminating the desulfurization process can be noticed. According to the invention it is possible to run a desulfurization of a storage catalyst with a least possible expenditure of energy and with a least possible thermal exposure with abating undesired side-products like hydrogen sulfide H2S.

### TECHNICAL FIELD

The invention is based on a procedure for the desulfurization of a storage catalyst and the device for the implementation of this procedure according to the category of independent claims.

### BACKGROUND

DE 197 39 848 A1 describes different operation procedures of a combustion engine, which has a NOx-storage catalyst arranged in its exhaust gas area. Due to the storage capacity of the NOx-storage catalyst a regeneration of the NOx-storage catalyst has to be provided now and then. The regeneration of the NOx-storage catalyst takes place due to the supply of hydrocarbon/carbon monoxide/hydrogen, which are provided interior powered. The provision of hydrocarbon/carbon monoxide is achieved by the rich operation of the combustion engine during the regeneration with an air level lambda smaller 1 or highest equal 1.

Because of the sulfur content in fuel a sulfur contamination of the NOx-storage catalyst occurs, which lowers the storage capacity of NOx-compounds.

DE 198 43 859 A1 describes a procedure for the desulfurization of NOx-storage catalyst. The sulfur contamination can be largely eliminated by impinging the NOx-storage catalyst at a high operating temperature of e.g. 600° C.-800° C. with hydrocarbon/carbon monoxide/hydrogen, which are provided for example interior power-operated by a rich operation of the combustion engine.

DE 100 40 010 A1 describes a procedure for obtaining the end of the desulfurization from the progress of a lambda signal of a lambda sensor, which is arranged downstream after the NOx-storage catalyst.

The required operating temperature of the storage catalyst for the implementation of the regeneration can be achieved by e.g. increasing the exhaust gas temperature or by e.g. directly heating the storage catalyst. The increasing of the exhaust gas temperature can be achieved for example by declining the effectiveness of the combustion engine. An advantageous possibility provides that combustive exhaust gas ingredients are brought in to the exhaust gas area of the combustion engine, which react exothermic on an available catalytic effective surface of the storage catalyst.

The punctual detection of at least one advantageous point of time for the ending of the desulfurization process lowers the thermal exposure of the storage catalyst. The detection of an advantageous point of time for the ending of the desulfurization process furthermore reduces the demand for reagents and limits the environmental pollution.

### SUMMARY

According to the invention for the desulfurization of a storage catalyst, particularly a NOx-storage catalyst there is the advantage that the process of the desulfurization is not maintained needless long. Where necessary the end of the desulfurization process coincides with the complete regeneration from a sulfur contamination of the catalytic converter. The desulfurization process thereby requires the lowest amount of reagent, which can be attained for example from fuel.

The storage catalyst is furthermore thermally encumbered as little as possible with a desulfurization temperature that is higher than the operating temperature.

According to the invention furthermore the release of hydrogen sulfide is almost completely prevented. A lower encumbrance of the environment with undesired substances is moreover achieved.

An essential advantage according to the invention is that the desulfurization of the storage catalyst can be monitored and influenced during the operation of the combustion engine by measurands instead of factors which are calculated by models.

Advantageous improvements and configurations of the invented procedure arise from dependent claims.

One configuration provides that at least one signal difference between the two measured signals is determined and that the most advantageous point of time for the ending of the desulfurization process is detected when the signal difference falls below a signal difference threshold.

One improvement of this configuration provides the determination of at least one signal difference variation of at least one ascertained signal difference between the measured signals in a foreseen desulfurization phase and at least one ascertained signal difference between the measured signals in the following desulfurization phases, and the most advantageous point of time for ending the desulfurization progress, when the signal difference variation falls below a signal difference variation threshold.

The detection of at least the most advantageous point of time for ending the desulfurization process on the basis of a comparison of an incoming lambda signal upstream before the storage catalyst with an outgoing lambda signal downstream after the storage catalyst, is possible with technical signal by using simple methods. Preferably an average value of at least two instead of one signal differences of a further signal evaluation is underlying. The averaging lowers the influence of noise and/or of interfering signals on the detection of the regeneration end.

A further configuration provides that at least one surface variation between the ascertained surface of a previous desulfurization phase and a subsequent desulfurization phase is detected between the two measured signals and that the most advantageous point of time for ending the desulfurization process is ascertained, when the surface variation falls below a surface variation threshold.

The detection of at least one advantageous point of time for terminating the desulfurization process based on the evaluation of the surface that is between both measured signals, provides a high accuracy, since the surface detection corresponds with an averaging. Preferably the whole surface that appears during the desulfurization phase between both measured signals is detected and taken as a basis for the evaluation. Using this method the best signal-noise-rate can be achieved.

One configuration provides a delay time during which the desulfurization process is continued after a lower threshold deviation. The initiation of the delay time ensures that the desulfurization process of the storage catalyst is as complete as possible.

According to the invention for the desulfurization of a storage catalyst an especially customized controller for the implementation of the procedure is provided.

The controller contains preferably at least one electric storage, which stores the steps of the procedure as a computer operation.

The invention concerns furthermore a program that shows all steps of the procedure, when it runs in a controller.

The invention furthermore concerns a program product with a program code, which is saved in a machine-readable media, for the implementation of the procedure, when the program is performed in a controller.

Further advantageous improvements and configurations of the invented procedure arise from further dependent claims and the following description.

### BRIEF DESCRIPTION OF THE DRAWINGS

It shows:

FIG. 1: technical surrounding, which contains the invented procedure and

FIGS. 2 and 3: signal progresses depending on the time.

### DETAILED DESCRIPTION

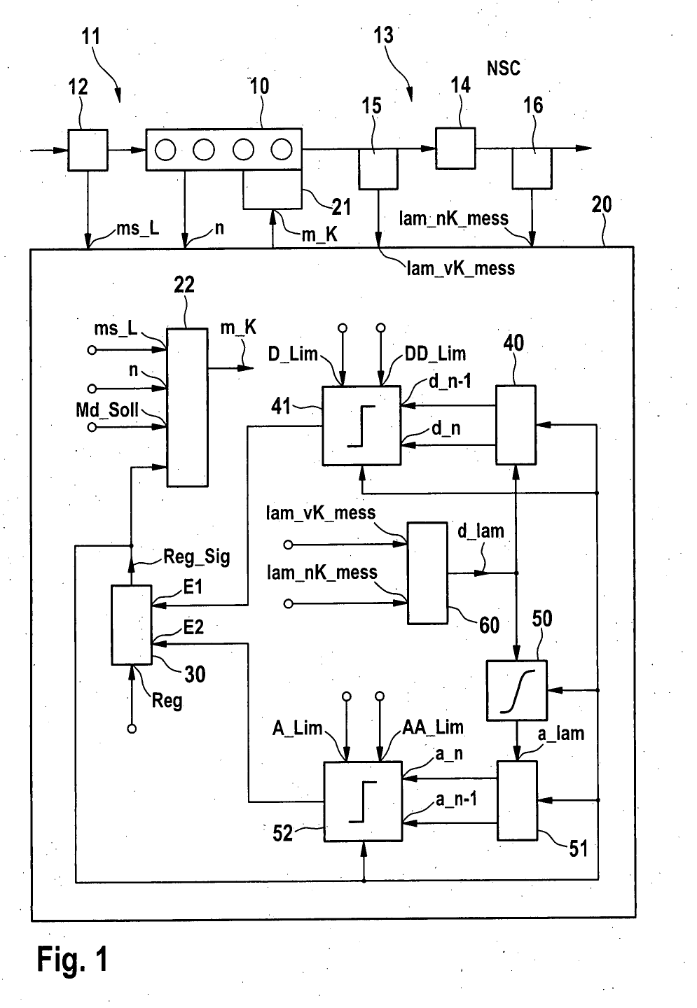

FIG. 1 shows a combustion engine 10, which has an air detection 12 in its intake area 11 and a storage catalyst 14 in its exhaust gas area. Upstream before the storage catalyst 14 there is a first lambda sensor 15 and downstream after the storage catalyst 14 there is a second lambda sensor 16.

The air detection 12 provides an air signal ms_L for the controller 20. The combustion engine 10 provides an engine speed n. The first lambda sensor 15 provides an incoming lambda signal lam_vK_mess and the second lambda sensor 16 an outgoing lambda signal lam_mK_mess. The controller 20 provides a fuel signal m_K for the fuel awarding 21.

The controller 20 contains a fuel signal determination 22, which is supplied with an air signal ms_L, the engine speed n, a torque set point Md_Soll as well as a desulfurization signal Reg_Sig and also a fuel signal m_K.

The desulfurization signal Reg_Sig provides a desulfurization-regulation 30 subject to a desulfurization-demand Reg. The desulfurization signal Reg_Sig is furthermore made available for a signal difference-storage 40, for a signal difference-comparator 41, for an integrator 50, for a surface-storage 51 as well as for a surface-comparator 52.

The incoming lambda signal lam_vK_mess and the outgoing lambda signal lam_nK_mess are made available for the difference ascertainment 60, which is provided for the signal difference-storage 40 and the integrator 50.

The signal difference-storage 40 provides a first signal difference d_n and a second signal difference d_n−1 for the signal difference comparator 41. The signal difference comparator 41 is furthermore supplied with a signal difference threshold D_Lim as well as with a signal difference variation threshold DD_Lim. The signal difference storage 41 provides a first desulfurization procedure-termination signal E1 for the desulfurization-regulation 30.

The integrator 50 provides a surface signal a_lam for the surface-storage 51. The surface storage 51 provides a first surface a_n and a second surface a_n−1 for the surface-comparator 52. The surface-comparator 52 is furthermore supplied with a surface-threshold A_Lim as well as with a surface variation threshold AA_Lim. The surface-comparator 52 provides a second desulfurization procedure-termination signal E2 for the desulfurization-regulation 30.

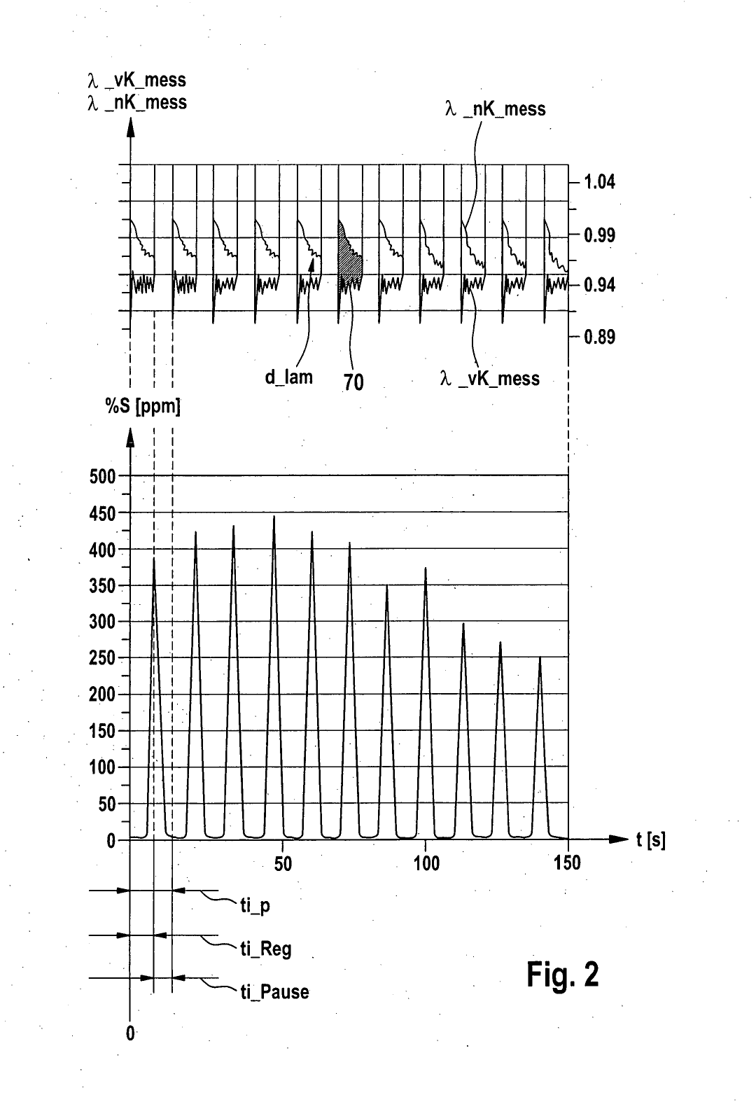

FIG. 2 shows signal progresses subject to the time t. The incoming lambda signal lam_vK-mess and the outgoing lambda signal lam_nK_mess, lying in the range of 0.89-1.04, are shown in the upper sub frame of FIG. 2. A dimension for the sulfur concentration % S, which is within the range of 0-500 ppm, is shown in the lower sub frame of FIG. 2.

Within the cycle duration ti_p a desulfurization phase ti_Reg and a desulfurization pause ti_Pause occur in a temporal alternation. The desulfurization phase ti_Reg and a desulfurization pause ti_Pause occur in a temporal alternation during the desulfurization, whereby FIG. 2 shows a period of 0-150 seconds. The upper sub frame lists signal difference d_lam and a surface 70, which occur in between the two measured signals lam_vK_mess, lam_nK_mess.

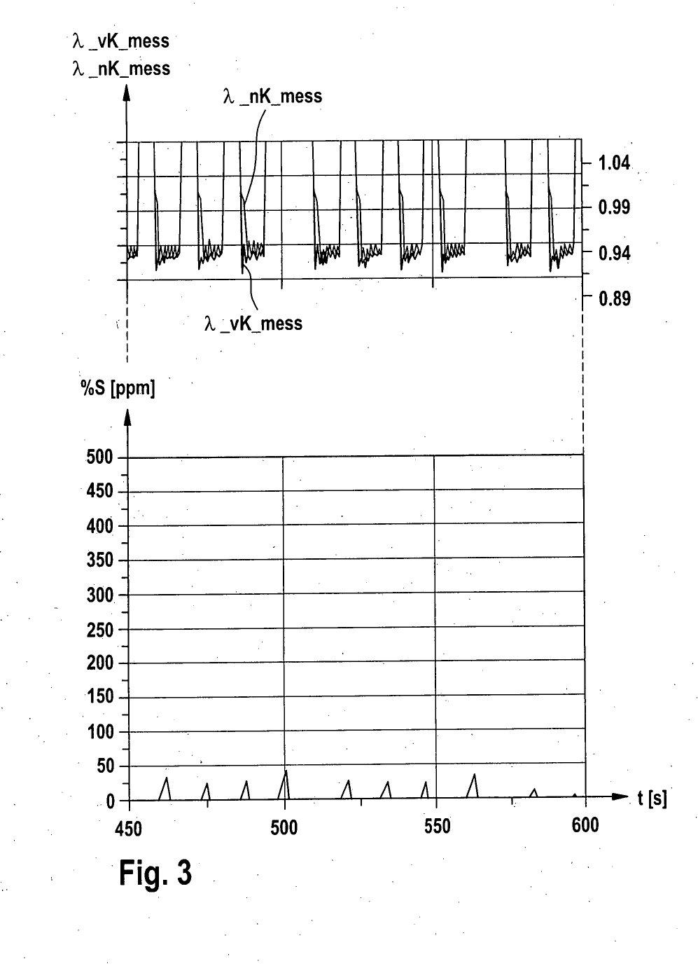

FIG. 3 shows signal progressions depending on the t which correspond with the signal progressions shown in FIG. 2, whereby the period is I a range of 450-600 seconds.

According to the invention it is proceeded as follows:

The combustion engine 10 can at least be operated in a fuel saving operation mode (lean operation), which can result in increased NOx-emissions. To eliminate these NOx-emissions the storage catalyst 14 is provided, which has a particular storage capacity, that is depending amongst others on the temperature of the storage catalyst 14. The storage catalyst 14 is charged cyclically and is exempted from the stored NOx within the framework of the regeneration.

The fuel saving operating mode is determined amongst others by the fuel signal m_K, which determines the point of time of at least one fuel injection and the amount of fuel that has to be measured per cycle segment of the combustion engine 10. The determination of a fuel injection moment is synonymous with the determination of the fuel injection to at least one of a fixed wave position of the combustion engine 10.

The fuel signal m_K is determined by the fuel signal determination 22 depending at least on the air signal ms_L, on the speed engine signal n and on the torque set point Md_Soll as well as on the desulfurization signal Reg_Sig.

During the operation of the storage catalyst 14 a sulfur contamination occurs, which advances subject to the sulfur concentration in the fuel and lubricant of the combustion engine. The sulfur contamination lowers the NOx-storage capacity of the storage catalyst 14. To regenerate the NOx-storage capacity a desulfurization of the storage catalyst 14 is proper from time to time.

The requirement of a desulfurization can be recognized by the mentioned sate of art according to the patent application DE 100 40 010. A required desulfurization is signalized by a desulfurization demand Reg.

The sulfur contained in the fuel can be specifically stored in a sulfur trap (not demonstrated), which is arranged in the exhaust gas area 13 of a combustion engine 10 upstream before the storage catalyst 14. The desulfurization of the sulfur trap is analog to the desulfurization of the storage catalyst 14. The sulfur trap is therefore equated with the storage catalyst 14 corresponding to the present patent application.

The desulfurization of the storage catalyst 14 takes places with a reagent substance, which contains for example carbon monoxide/hydrocarbon/hydrogen. Preferably the reagent substance is produce interior powered, as long as the exhaust gas of the combustion engine 10 can provide the required reagent substance by a suitable control of the combustion engine 10. In the displayed implementation model it is assumed that the combustion engine 10 can provide the reagent substance by a rich operation, during which an air lambda of at most even 1 occurs in the exhaust gas of the combustion engine 10. Alternatively or additionally the reagent substance can be introduced directly into the exhaust gas area 13 downstream of the combustion engine 10.

The rich operation of the combustion engine 10, during which a exhaust gas lambda of at most even 1 occurs, is achieved by a lambda regulator (not demonstrated), which is supplied with the actual value of the incoming lambda signal lam_vK_mess provided by the first lambda sensor 15. The first lambda sensor 15 is a broadband lambda sensor, which can provided a dimension for the air lambda at a rich as well as at a lean exhaust gas lambda.

After the occurrence of the desulfurization demand Reg the desulfurization regulation 30 provides the desulfurization signal Reg_Sig, which causes the fuel signal ascertainment 22 to change the fuel signal m_K accordingly, in order to allow the desulfurization of the storage catalyst 14. In a first not displayed step the operating temperature of the storage catalyst 14 is increased from the nominal operating temperature to a required desulfurization operating temperature, which is within the range of e.g. 600° C.-800° C. When the storage catalyst 14 reaches the desulfurization operating temperature, the storage catalyst 14 is impinged in a temporal variation with a regeneration gas and an oxygen containing gas, which can—as already mentioned—be provided interior powered. In the displayed implementation model it is assumed that the temporal variations between the desulfurization phase ti_Reg and the desulfurization pause ti_Pause occur during the desulfurization, which generally can last for a couple of minutes, with a cycle duration ti_P, which is for example 10 seconds. The desulfurization phase ti_Reg can last for example for 5 seconds and the desulfurization pause ti_Pause for 5 seconds as well. The indicated times can vary during the desulfurization.

The guideline for the desulfurization phase ti_Reg and the desulfurization pause ti_Pause during the desulfurization prevents the development of hydrogen sulfide H2S. During the desulfurization pauses ti_Pause the storage catalyst 14 is impinge with oxygen containing exhaust gas in order to fill up the oxygen storage of the storage catalyst. The exhaust gas lambda is determined to be for example 1.1-1.4 during the desulfurization pauses ti_Pause. The exhaust gas lambda upstream before the storage catalyst 14 is at about 0.94 during the desulfurization phases ti_Reg.

Downstream after the storage catalyst 14 a second lambda sensor 16, which is a broadband lambda sensor as well, detects the outgoing lambda signal lam_nK_mess, this progress being each shown in the upper sub frame of FIGS. 2 and 3.

It has been determined experimentally that a favorable point of time for terminating the desulfurization process of the storage catalyst 14 can be determined with only one comparison of both signals lam_vK_mess, lam_nK mess by a proper lambda sensor 15, 16, which provides at least one dimension for each of the actually occurring exhaust gas lambdas. Proper lambda sensors are broadband lambda sensors, which are described for example in the specialist book “Ottomotor-Management/Bosch”, published by Vieweg, 1. edition, 1998, page 22-23.

As long as the oxygen storage of the storage catalyst 14 is at least partly deactivated during the desulfurization process, the desulfurization process can be terminated according to the invention, since a further performance of the regeneration would not result in a further desulfurization.

According to a first implementation model at least one difference between both signals lam_vK-mess, lam_nK_mess during the desulfurization phase ti_Reg acquired by the difference determination 60 and provided as a signal difference d_lam to the signal difference storage 40. As a matter of principle the comparison of one signal difference d_lam with the signal difference threshold D_Lim is sufficient. In this case the first signal difference d_n equals the second signal difference d_lam. But preferably more signal differences d_lam are averaged before a comparison with the signal difference threshold lam_vK_mess, in order to minimize the influence on the result of interfering impulses on the one hand, and signal fluctuations of the signals lam_vK_mess, lam_nK_mess on the other hand.

The at least one signal difference d_lam is acquired by the scanning level of the two signals lam_vK_mess, lam_nK_mess, whereas the scanning cycle duration is significantly shorter than the cycle duration ti_P. A special advantage is to acquire the signal difference d_lam at the end of the desulfurization phase ti_Reg since both signals lam_vK_mess, lam_nK_mess, especially the outgoing lambda signal lam_nK_mess, demonstrate stabilized levels at this point of time.

According to the self-improvement it is intended that signal differences d_lam are acquired in different desulfurization phases ti_Reg and evaluated with regard to a variation. The at least one signal difference d_lam, that has been acquired in different desulfurization phases ti_Reg, is deposed in the signal difference storage 40, which provides the first and second signal difference d_n, d_n−1 simultaneously, whereby the first signal difference d_n has been acquired in a different desulfurization phase ti_Reg than the second signal difference d_n−1. Preferably an averaging of signal differences d_lam is intended before the comparison as well, which were acquired during one desulfurization phase ti_Reg. The signal difference comparator 41 provides a difference between the first and second signal difference d_n, d_n−1, the acquired difference, which corresponds with a variation of differences, with a signal difference variation threshold DD_Lim.

As long as the signal difference comparator 41 either detects a threshold lower deviation of the signal difference threshold D_Lim and/or of the signal difference variation threshold DD_Lim, the signal difference comparator 41 provides the first desulfurization process termination signal E1, which is induced the desulfurization regulation 30 to take the desulfurization signal Reg_Sig back in order to terminate the desulfurization process of the storage catalyst 14 this way.

The first desulfurization process termination signal E1 is preferably effective after a specified time delay.

According to a very advantageous configuration, which can be intended alternatively or additionally for the first configuration, the comparison of both signals lam_vK_mess, lam_nK_mess is based on an evaluation of the surface 70 that is stretched between the two signals lam_vK_mess, lam_nK_mess.

According to a simple configuration it can be intended that at least one part of the surface 70 is determined during a desulfurization phase ti_Reg between the two signals lam_vK_mess, lam_nK_mess. But preferably the whole surface 70 a desulfurization phase ti_Reg between the two signals lam_vK_mess, lam_nK_mess is used as a basis for the evaluation during.

For this purpose the difference-determination 60 is for example added to the integrator 50 in form of individual scanning levels of the provided signal differences d_lam. During a part or the entire desulfurization phase ti_Reg the integrator undertakes an integration of the signal differences d_lam, which corresponds to a surface determination. The resulting surface signal a_lam is supplied to the surface signal storage 51.

According to a simple configuration it is intended that the surface signal a_lam is directly compared to the surface threshold A_Lim in the surface comparator 52. According to another configuration it is intended that a possibly occurring variation of surfaces 70 is evaluated between the desulfurization phases ti_Reg. Therefore the surface storage 51 stores at least two acquired surface signals a_lam, that have been obtained in at least two different desulfurization phases ti_Reg, for example two directly sequenced desulfurization phases ti_Reg. These surface signals a_lam are supplied as surface signal a_n, a_n−1 to the surface comparator 52, which determines the difference between the first and the second surface signal a_n, a_n−1 and which compares the corresponding difference of a variation of the surface to the surface variation threshold AA_Lim.

As long as the surface comparator 52 detects a lower deviation of the surface threshold A_Lim and/or of the surface variation threshold AA_Lim, the surface comparator 52 provides the second desulfurization process termination signal E2, which induces the desulfurization regulation 30 to take the desulfurization signal Reg_Sig back in order to terminate the desulfurization process of the storage catalyst 14.

Preferably the second desulfurization process termination signal E2 becomes effective after a specified time delay.

In the lower sub frame of FIG. 2 there is a dimension for the sulfide concentration % S in ppm listed, which can be determined downstream after the storage catalyst 14 during the desulfurization. The peak values of the dimension of the sulfide concentration % S occurs each time-delayed in relation to the beginning of the desulfurization phases ti_Reg. After an initial increase of the peak value of the dimension of the sulfide concentration S % up to the 50^{th} second for example, there is a continuing decrease, until after a few minutes a dimension for the sulfide concentration % S is reached, which does not have to be fallen below for a successful desulfurization.

In FIG. 3 a situation is shown, which might occur for example between the 450^{th}-600^{th} second. In the upper sub frame of FIG. 3 is can be noticed that both signals lam_vK_mess, lam_nK_mess almost concur. An expansion of the desulfurization process until this time range would therefore—if at all—only cause a marginal improvement of the desulfurization result. In the displayed implementation model the perfect point of time would be therefore between the 150^{th}-450^{th} second, e.g. at 300 seconds. The perfect point of time to detect the favorable point of time for the termination of the desulfurization process, at which the first and second desulfurization process termination signals E1, E2 occur, can be acquired by a suitable determination of the at least one threshold D_Lim, DD_Lim, A_Lim, AA_Lim. Expediently it is proceeded experimentally.

1. A method of desulfurization of a storage catalyst, the method comprising in a temporal shift, admitting the storage catalyst with a regeneration gas of a maximum air lambda of 1 in the desulfurization phase and admitting with a regeneration gas having an air lambda of higher than 1 in a desulfurization pause;
detecting an incoming lambda signal upstream before the storage catalyst;
detecting an outgoing lambda signal downstream after the storage catalyst; and
determining, at least one favorable point of time, a termination of the desulfurization process by a comparison of the incoming and outgoing lambda signals.

2. A method according to claim 1, further comprising ascertaining at least one signal difference between the incoming and outgoing lambda signals and wherein determining includes determining the termination of the desulfurization when the signal difference falls below a signal difference threshold.

3. A method according to claim 1, further comprising ascertaining at least one signal difference variation between at least one signal difference between the incoming and outgoing lambda signals, which have been detected during a previous desulfurization phase, and at least one detected signal difference between the incoming and outgoing lambda signals, which have been detected during a subsequent desulfurization phase, and wherein determining includes determining the termination of the desulfurization process if the signal difference variation falls below a signal difference variation threshold.

4. A method according to claim 2, further comprising determining an average of at least two signal differences.

5. A method according to claim 2, further comprising detecting at least one signal difference at the end of the desulfurization phases.

6. A method according to claim 1, further comprising determining at least one part of a surface between the incoming and outgoing lambda signals and wherein determining includes determining the termination of the desulfurization process if the part of the surface falls below a surface threshold.

7. A method according to claim 1, further comprising determining at least one surface variation between a part of the surface between the incoming and outgoing lambda signals, which have been acquired during a previous desulfurization phase and a subsequent desulfurization phase, and wherein determining includes determining a termination of the regeneration process, if the surface variation falls bellow a surface variation threshold.

8. A method according to claim 6, wherein determining at least one surface includes determining an entire surface between the two signals, that emerged during a desulfurization phase.

9. A method according to claim 2, further comprising designating a time delay, during which the desulfurization process is continued after a lower deviation of the threshold.

10. A device for the desulfurization of a storage catalyst, comprising a customized controller that, in a temporal shift, admits the storage catalyst with a regeneration gas of a maximum air lambda of 1 in the desulfurization phase and admits with a regeneration gas having an air lambda of higher than 1 in a desulfurization pause;
detects an incoming lambda signal upstream before the storage catalyst;
detects an outgoing lambda signal downstream after the storage catalyst; and
determines, at least one favorable point of time, a termination of the desulfurization process by a comparison of the incoming and outgoing lambda signals.
